(19) United States
(12) Patent Application Publication
(10) Pub. No.: US 2008/0315010 A1
(43) Pub. Date: Dec. 25, 2008

(54) Fuel Injector

(76) Inventors: Peter Jarvis Goodwin, Lincoln (GB); Peter Senior, Leicester (GB); Nigel Wilbraham, West Midlands (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/884,511

(22) PCT Filed: Feb. 17, 2006
(86) PCT No.: PCT/EP06/60050

§ 371 Date: Jun. 19, 2008

(30) Foreign Application Priority Data
Feb. 19, 2005 (GB) 0503497.0

(51) Int. Cl. B05B 1/24

(52) U.S. Cl. 239/135

(57) ABSTRACT

A fuel injector comprising: a fuel supply conduit for conveying fuel from a base end of the fuel injector to a tip end of the injector; a nozzle at the tip end of the injector for injecting the fuel into a combustion chamber; thermal conductor means for conducting heat from said nozzle at the tip end of the injector to the base end of the injector to cool the nozzle; and a housing for said fuel supply conduit, said nozzle and said thermal conductor means, wherein said thermal conductor means is thermally insulated from said fuel supply conduit between said tip and base ends of the injector.

### CROSS REFERENCE TO RELATED APPLICATIONS

This application is the US National Stage of International Application No. PCT/EP2006/060050, filed Feb. 17, 2006 and claims the benefit thereof. The International Application claims the benefits of British application No. 0503497.0 filed Feb. 19, 2005, both of the applications are incorporated by reference herein in their entirety.

### FIELD OF INVENTION

This invention relates to a fuel injector. More particularly, the invention relates to a fuel injector comprising: a fuel supply conduit for conveying fuel from a base end of the fuel injector to a tip end of the injector; a nozzle at the tip end of the injector for injecting the fuel into a combustion chamber; and a housing for the fuel supply conduit and the nozzle.

### BACKGROUND OF THE INVENTION

It is important to carefully manage the temperature of the nozzle at the tip end of the injector so as to avoid the formation of carbon deposits on the internal surfaces of the nozzle and the fuel supply conduit to the nozzle. Such carbon deposits potentially arise due to chemical cracking of the liquid fuel at temperatures exceeding known values. For example, diesels and kerosenes typically chemically crack at temperatures exceeding about 200° C.

It is known to tolerate the formation of a certain amount of carbon provided the flow rate of the liquid fuel through the fuel supply conduit and nozzle is sufficiently high to prevent most of this carbon from adhering to the internal surfaces of these components. This approach has been used in fuel injectors for gas turbine engines, where there is careful control of the near wall Reynolds numbers in the regions of the fuel supply conduit and nozzle at greatest risk. Thus, in such fuel injectors the temperature of the nozzle may exceed 200° C. However, a problem arises where the gas turbine engine is required to operate over a wide range of loads such that the liquid fuel flow rate may reduce but the nozzle temperature remain around or above 200° C. This occurs for example in gas turbine engines employing so called staged systems such as those used on Dry Low Emissions (DLE) combustors.

### SUMMARY OF INVENTION

According to the present invention there is provided a fuel injector comprising: a fuel supply conduit for conveying fuel from a base end of the fuel injector to a tip end of the injector; a nozzle at the tip end of the injector for injecting the fuel into a combustion chamber; thermal conductor means for conducting heat from said nozzle at the tip end of the injector to the base end of the injector to cool the nozzle; and a housing for said fuel supply conduit, said nozzle and said thermal conductor means.

In a first fuel injector according to the present invention said housing extends the full length of said fuel supply conduit.

In a second fuel injector according to the present invention said housing does not extend along a mid-portion of the length of said fuel supply conduit such that over this mid-portion the fuel supply conduit and said thermal conductor means are exposed to the exterior of said fuel injector.

Preferably, said thermal conductor means is in physical contact with said nozzle, but is thermally insulated from both said fuel supply conduit and said housing between said tip and base ends of the injector. The thermal insulation suitably comprises a physical spacing between said thermal conductor means and both said fuel supply conduit and said housing between said tip and base ends of the injector.

Preferably, there is minimal physical contact between said thermal conductor means and said housing at the tip end of the injector.

Preferably, said thermal conductor means is recessed from the end face of said tip end of the injector, and said housing is formed so as to extend between said thermal conductor means and said end face of said tip end of the injector.

Preferably, said thermal conductor means is in physical contact with said housing at the base end of the injector.

Preferably, cooling is applied to said base end of the injector. The cooling is suitably achieved by utilising assist gas used by the injector to assist in the injection of fuel into the combustion chamber.

Preferably, said thermal conductor means is in the form of a tube which extends between said tip and base ends of the injector, and surrounds and is co-axial with said fuel supply conduit.

### BRIEF DESCRIPTION OF THE DRAWINGS

The invention will now be described, by way of example, with reference to the accompanying schematic drawings, in which:

FIG. 1 a longitudinal cross-section of the first fuel injector,

FIG. 2 a longitudinal cross-section of the second fuel injector,

FIG. 3 a longitudinal cross-section of the third fuel injector, and

FIG. 4 a longitudinal cross-section of the fourth fuel injector.

### DETAILED DESCRIPTION OF INVENTION

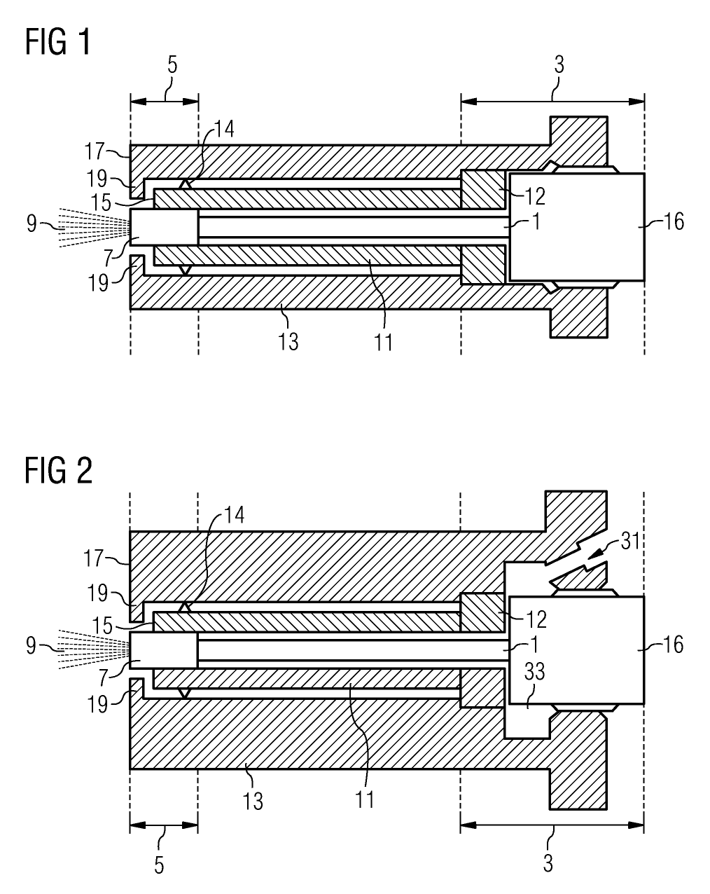

Referring to FIG. 1, the first fuel injector comprises: a fuel supply conduit 1 for conveying fuel from a base end 3 of the fuel injector to a tip end 5 of the injector; a nozzle 7 at tip end 5 for injecting the fuel into a combustion chamber, see fuel spray 9; a tube 11 of high thermal conductance for conducting heat from nozzle 7 at tip end 5 to base end 3 to cool nozzle 7; and a housing 13 for fuel supply conduit 1, nozzle 7 and tube 11.

At tip end 5 tube 11 is in physical contact with nozzle 7 such as to achieve good thermal communication with nozzle 7. Similarly, at base end 3 tube 11 is in physical contact with housing 13 such as to achieve good thermal communication with housing 13. This physical contact is achieved by means of flange 12 of tube 11. Between tip end 5 and base end 3, tube 11 is physically spaced from both fuel supply conduit 1 and housing 13 so as to be thermally insulated from these components between the tip and base ends. At tip end 5 tube 11 is centered within housing 13 by location means 14. The form of location means 14 must be such that there is minimal physical contact between tube 11 and housing 13 so as to ensure minimal thermal communication between these components. Accordingly, location means 14 suitably comprises posts having tapered ends or a ring having a knife edge. At base end 3 fuel supply conduit 1 communicates with fuel supply end fitting 16.

The end 15 of tube 11 at tip end 5 of the injector is recessed from the end face 17 of tip end 5 so as to distance tube 11 from the heat at end face 17. Further, housing 13 includes shroud formation 19 which extends between end 15 of tube 11 and end face 17 to screen tube 11 from the heat at end face 17.

In use of the fuel injector, a temperature gradient is present along tube 11 between hot tip end 5 and much cooler base end 3. Consequently, heat within nozzle 7 is conducted along tube 11 to base end 3 to cool nozzle 7 and fuel supply conduit 1. The minimal physical contact between tube 11 and housing 13 ensures that heat take-up by tube 11 is almost exclusively from nozzle 7, i.e. ensures that tube 11 operates to cool nozzle 7 only and not housing 13. The spacing between tube 11 and both fuel supply conduit 1 and housing 13 ensures that the temperature gradient along tube 11 is not upset by thermal communication with either of these components. The recessing of end 15 of tube 11, and the screening of end 15 by shroud formation 19, ensures minimal take-up by tube 11 of the heat at end face 17 of tip end 5, thereby maximising heat take-up from nozzle 7.

Tube 11 is suitably made from aluminium, copper or magnesium. In the case of copper it is appropriate to coat the tube, eg with chrome, to protect against interaction with nickel that may be present in the fuel injector/engine. Tube 11 may also be made from tungsten or graphite. In the case of graphite the tube would be constructed from discrete pieces of graphite, eg bars of graphite, assembled within an appropriate support structure, eg of aluminium or other metal, due to the low strength of graphite. Each of the discrete pieces of graphite would be appropriately directionally oriented to provide the high thermal conductance.

It is to be realised that there are principally two paths by which heat present in nozzle 7 may be conducted away from nozzle 7. These paths are high conductance tube 11 and fuel supply conduit 1. It is of course desired to minimise the heat taken by fuel supply conduit 1 so as to minimise/prevent chemical cracking of the fuel within conduit 1. The design of the fuel injector should be such that at the very least 60% of the heat flux is taken by tube 11 with the remaining 40% taken by fuel supply conduit 1. It is preferable that at least 80% of the heat flux is taken by tube 11 with the remaining 20% taken by conduit 1. It is more preferable that at least 90% of the heat flux is taken by tube 11 with the remaining 10% taken by conduit 1.

Additional cooling of base end 3 may be used to make steeper the temperature gradient along tube 11 and hence improve the efficiency of cooling of nozzle 7 and fuel supply conduit 1. An example of such additional cooling is present in the second fuel injector of FIG. 2.

In the second fuel injector of FIG. 2 like parts to those of the first fuel injector of FIG. 1 are labelled with the same reference numerals. The second fuel injector differs from the first in that air is used to assist the formation of fuel spray 9, and also to help cool base end 3 of the fuel injector. Thus, air enters via port 31, circulates around air assist gallery 33 to help cool base end 3, travels between flange 12 and fitting 16, travels along the space between fuel supply conduit 1 and tube 11, and enters nozzle 7 where it assists in known manner the formation of fuel spray 9.

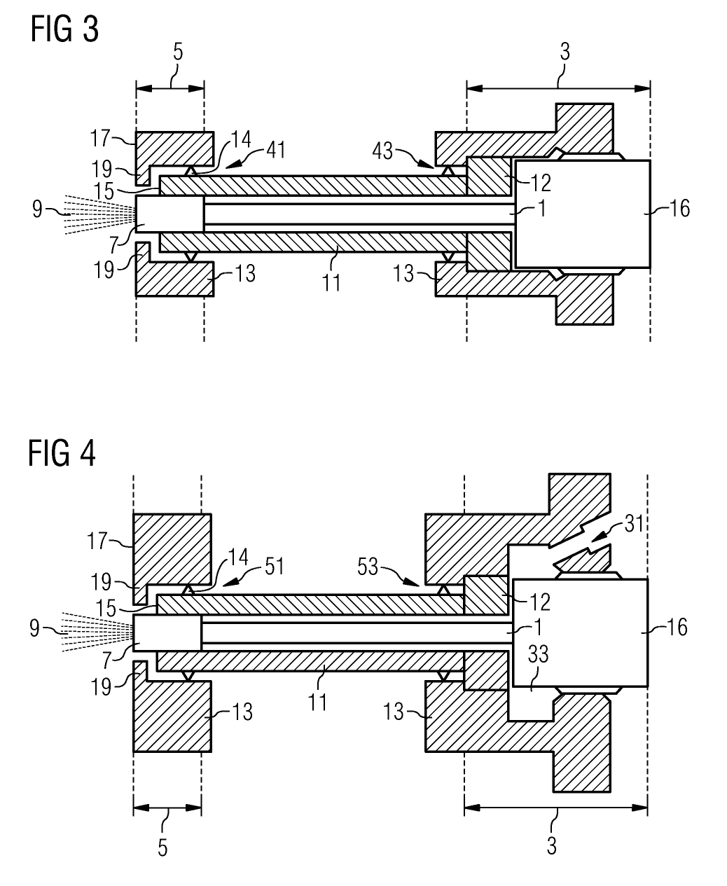

In the third fuel injector of FIG. 3 like parts to those of the first fuel injector of FIG. 1 are labelled with the same reference numerals. The third fuel injector differs from the first in that housing 13 does not extend along a mid-portion of the length of fuel supply conduit 1 and tube 11 such that over this mid-portion conduit 1 and tube 11 are exposed to the exterior of the fuel injector. In other words, at region 41 conduit 1 and tube 11 leave housing 13 so as to be exposed to the exterior of the fuel injector, to return to housing 13 at region 43.

In the fourth fuel injector of FIG. 4 like parts to those of the second fuel injector of FIG. 2 are labelled with the same reference numerals. The fourth fuel injector differs from the second in that housing 13 does not extend along a mid-portion of the length of fuel supply conduit 1 and tube 11 such that over this mid-portion conduit 1 and tube 11 are exposed to the exterior of the fuel injector. In other words, at region 51 conduit 1 and tube 11 leave housing 13 so as to be exposed to the exterior of the fuel injector, to return to housing 13 at region 53.

It is to be appreciated that a fuel injector according to the present invention when utilised in a gas turbine engine increases the load range over which the engine may operate without risk of problem due to carbon deposits. It does this by very efficiently cooling the nozzle of the fuel injector. This enables the flow rate of fuel within the injector to drop without risk that the flow is then insufficient to prevent the adherence of carbon deposits on the internals of the injector.

1.-16. (canceled)

17. A fuel injector comprising:
a fuel supply conduit for conveying fuel from a base end of the fuel injector to a tip end of the injector;
a nozzle arranged at the tip end of the injector for injecting a fuel into a combustion chamber;
a thermal conductor that conducts heat from the nozzle at the tip end of the injector to the base end of the injector to cool the nozzle and recessed from an end face of the tip end of the injector; and
a housing for the fuel supply conduit, the nozzle and the thermal conductor, wherein the thermal conductor is thermally insulated from the fuel supply conduit between the tip and base ends of the injector and the housing extends between the thermal conductor and the end face of the tip end of the injector and screens an end of the thermal conductor by shroud formation.

18. The injector according to claim 17, wherein the housing extends the full length of the fuel supply conduit.

19. The injector according to claim 17, wherein the housing does not extend along a mid-portion of the length of the fuel supply conduit such that the fuel supply conduit and the thermal conductor means are exposed to the exterior of said fuel injector.

20. The injector according to claim 19, wherein the thermal conductor is in physical contact with the nozzle, and is thermally insulated from the housing between the tip and the base ends of the injector.

21. The injector according to claim 20, wherein the thermal insulation comprises a physical spacing between the thermal conductor and both the fuel supply conduit and the housing between the tip and base ends of the injector.

22. The injector according to claim 21, wherein there is minimal physical contact between the thermal conductor and the housing at the tip end of the injector.

23. The injector according to claim 22, wherein the thermal conductor is in physical contact with the housing at the base end of the injector.

24. The injector according to claim 23, wherein cooling is applied to the base end of the injector.

25. The injector according to claim 24, wherein the cooling is achieved by utilizing assist gas used by the injector to assist in the injection of fuel into the combustion chamber.

26. The injector according to claim 25, wherein the thermal conductor is a tube that extends between the tip and base ends of the injector, and surrounds and is co-axial with the fuel supply conduit.

27. The injector according to claim 26, wherein the thermal conductor comprises a material selected from the group consisting of: aluminum, copper, magnesium, tungsten and graphite.

28. The injector according to claim 27, wherein the thermal conductor is sized and configured to conduct at least 60% of the heat flux from the nozzle.

29. The injector according to claim 27, wherein the thermal conductor is sized and configured to conduct at least 80% of the heat flux from the nozzle.

30. The injector according to claim 27, wherein the thermal conductor is sized and configured to conduct at least 90% of the heat flux from said nozzle.

31. The injector according to claim 27, wherein the injector is a fuel injector for a gas turbine engine.
